(19) United States
(12) Patent Application Publication
(10) Pub. No.: US 2017/0135349 A1
(43) Pub. Date: May 18, 2017

(54) COMPOSITION WITH PEST RESISTANT PROPERTIES

(71) Applicant: VectorBlock LLC, New York, NY (US)

(72) Inventor: Kevin McAllister, New York, NY (US)

(21) Appl. No.: 15/179,379

(22) Filed: Jun. 10, 2016

Related U.S. Application Data
(60) Provisional application No. 62/256,534, filed on Nov. 17, 2015.
(60) Provisional application No. 62/256,553, filed on Nov. 17, 2015.

(51) Int. Cl. A01N 59/16; A01N 65/44; A01N 25/26

(52) U.S. Cl. CPC A01N 59/16; A01N 25/26; A01N 65/44

(57) ABSTRACT

A composition for topical administration containing particles and a pharmaceutically acceptable carrier. The particles may be composed of a metal oxide such as titanium oxide or zinc oxide, and may be coated with an external coating. The composition may also contain one or more organic components that are either bound or unbound to the particles. The composition may be used to prevent mosquitoes from extracting blood from a host and/or from infecting a host with a mosquito-borne disease or infection, or to protect a host from blood extraction and/or infection by a mosquito.

### CROSS-REFERENCE TO RELATED APPLICATIONS

This application claims the benefit of U.S. Provisional Application No. 62/256,534, filed on Nov. 17, 2015, and of U.S. Provisional Application No. 62/256,553, filed on Nov. 17, 2015, the contents of both provisional applications are incorporated by reference herein, in their entireties and for all purposes.

### FIELD OF INVENTION

This invention relates generally to the field of mosquito-borne disease control but may be applicable to other pest-related vector control. In the case of mosquito vector control, the invention relates to a topical composition which prevents the mosquito from both feeding and—as a consequence—infecting humans and possibly other mammals with mosquito-borne diseases.

### BACKGROUND OF THE INVENTION

Mosquitoes at their most benign are annoying and bothersome to humans and animals. The bite of the female mosquito as it seeks blood usually causes an adverse reaction that results in itching, swelling, or sores. Of greater concern, mosquitoes are considered one of the most dangerous creatures on the planet because of their ability to spread deadly diseases. The U.S. Centers for Disease Control report that these insects kill more than one million people a year just through the transmission of malaria. Add to that the number of those sickened and killed by other mosquito-borne diseases such as dengue fever, yellow fever, and West Nile virus, and it is easy to see how they earned their dangerous reputation. In recent years the rate of infection has risen dramatically, and a growing number of scientists are now concerned that global warming will translate into an explosive growth of mosquito-borne diseases worldwide.

Mosquitoes inhabit our globe in two distinct environments. The immature stages of the mosquito (larva and pupa) live, feed, and metamorphose in aqueous settings until emerging in the winged adult stage, when the mosquito is capable of flight. After hatching from the egg there are four identifiable larval stages, in which the mosquito is designated as being a first, second, third, and fourth instar larva. The larvae actively feed and shed their exoskeletons with each transition between instars, each instar lasts approximately 1 to 2 days. The larvae then enter the pupae stage, a non-feeding stage during which the pupae undergo an energy-demanding metamorphosis into the adult mosquito.

Female mosquitoes are the only mosquitoes to feed on blood, although they do not need blood to survive. They do, however, need blood, or actually the protein in blood, for their eggs to develop. They must take a blood meal as part of their reproductive cycle. If they do not, the eggs that they lay will not be viable.

When preparing to bite its prey, a mosquito uses heat sensors on its antennae and around its mouthparts to locate capillaries near the prey's skin surface. The mosquito has a proboscis, which is a long, pointed mouthpart that is inserted to tap the capillary. There are two tubes in the proboscis. The mosquito uses one tube to inject saliva, while the other draws in blood. The saliva contains enzymes that serve two purposes: (1) to act as a mild painkiller, so the prey does not notice, and (2) to thin the blood so that it does not clot and continues to flow. It is through the saliva that the mosquito infects humans with disease. When the saliva enters the capillary, it brings with it the disease vectors with which it is infected. In addition, the mosquito may become infected with a disease from the prey via the blood it ingests.

Known methodologies for addressing this mosquito problem include physical abatement, entrapment systems using attractants, mosquitocidal bacteria, larvicides, adulticides, placement of larval predators in water bodies, adhesive traps, citronella candles, mosquito magnets, etc. Many of the methodologies are only successful against a small number of mosquitoes, while others require the introduction into the general environment of potentially harmful or toxic chemicals, such as petroleum-based oils or phenols.

One of the most effective chemical repellents is N,N-Diethyl-meta-toluamide—commonly referred to as DEET. It is hypothesized that DEET repels mosquitos by interfering with the mosquitos' odor receptors. However, DEET, like other chemical repellents, are volatile and are easily absorbed through skin, where it eventually enters the blood stream and the liver. Thus, there is an ongoing debate about the safety in using DEET, especially for children. Additionally, DEET is costly to manufacture and is not environmentally-friendly.

Thus, there is a need for a more effective and safe solution to combat the growing presence of mosquitoes and the diseases they carry.

### SUMMARY OF THE INVENTION

An aspect of the invention relates to a composition comprising particles that interrupt feeding of the mosquito, and a pharmaceutically acceptable carrier.

The particles may comprise one or more metal oxides, for example, titanium dioxide, zinc oxide, or a combination thereof. In some embodiments, the particles are titanium dioxide, either rutile or anatase.

The particles may also comprise an external coating. The external coating may comprise, for example, a hydrophilic polymer, propylene, propylene glycol phospholipid derivative such as lecithin, or a combination thereof.

The composition may comprise one or more organic components. In certain embodiments, the organic components may have an effect on mosquitoes, such as to deter, repel, and/or irritate the mosquitos. Examples of such organic components may include, but are not limited to, pure forms or derivatives of lemongrass, citronella, picaridin (ir3535), chrysanthemum, cedar, soybean, and a combination thereof.

The one or more organic components may be bound or unbound to the particles. In some embodiments, more than one organic component may be bound to a single particle.

In certain embodiments, one or more organic components may be bound to a particle by being infused in an external coating on the particle.

The composition of the invention may be for use in a method of preventing mosquitoes from extracting blood from a host and/or from infecting a host with a mosquito-borne disease or infection, or a method of protecting a host from blood extraction and/or infection by a mosquito.

Another aspect of the invention is a method of preventing mosquitoes from extracting blood from a host and/or from infecting a host with a mosquito-borne disease or infection, or a method of protecting a host from blood extraction and/or infection by a mosquito. The method may comprise applying a composition of the invention to the dermis.

Yet another aspect of the invention is a method of preparing a composition of the invention. The method may comprise admixing the components of the composition.

A further aspect of the invention is a use of the composition of the invention in the preparation of a medicament for preventing mosquitoes from extracting blood from a host and/or from infecting a host with a mosquito-borne disease or infection, or for protecting a host from blood extraction and/or infection by a mosquito. This protection and/or prevention may be achieved by applying the medicament to the dermis of the host.

### BRIEF DESCRIPTION OF THE DRAWINGS

For a better understanding of the present invention, reference is made to the following description of an exemplary embodiment thereof, and to the accompanying drawings, wherein:

FIG. 1 shows scanning electron microscopy images (30000×) of uncoated 10% dimethicone titanium dioxide particles in a pharmaceutically acceptable carrier and 10% titanium dioxide particles coated with lecithin.

FIG. 2 shows scanning electron microscopy images (3000×) of uncoated 10% dimethicone titanium dioxide particles in a pharmaceutically acceptable carrier and 10% titanium dioxide particles coated with lecithin.

FIG. 3 shows an assembly of Petri dishes for a study described in Example 1.

FIG. 4 shows the Petri dishes from FIG. 3 through a thermal imaging apparatus.

FIG. 5 shows a visual comparison of the mosquito feeding activity for Petri dishes (i) serving as a control, (ii) covered with a pharmaceutically-acceptable carrier, (iii) covered with a composition containing 10% titanium dioxide coated with lecithin; and (iv) covered with a composition containing 15% titanium dioxide coated with lecithin.

FIG. 6 shows a scanning electron microscopy image (250×) of the sheathed proboscis of a mosquito exposed to titanium dioxide particles according to embodiments of the invention.

FIG. 7 shows a scanning electron microscopy image (700×) of the front of the proboscis of a mosquito exposed to titanium dioxide particles according to embodiments of the invention.

FIG. 8 shows a scanning electron microscopy image (5480×) of an area of mouth/proboscis of a mosquito exposed to titanium dioxide particles according to embodiments of the invention.

FIG. 9 shows a scanning electron microscopy image (3030×) of an area near the entry of the proboscis of a mosquito exposed to titanium dioxide particles according to embodiments of the invention.

FIG. 10 shows a scanning electron microscopy image (8480×) of an area of mouth/proboscis of a mosquito exposed to titanium dioxide particles according to embodiments of the invention.

FIG. 11 shows a scanning electron microscopy image (2073×) of an area of the mouth/proboscis of a mosquito exposed to titanium dioxide particles according to embodiments of the invention.

FIG. 12 shows a magnified image of FIG. 11 (4400×).

FIG. 13 shows a scanning electron microscopy image (7410×) of an area of mouth/proboscis of a mosquito exposed to titanium dioxide particles according to embodiments of the invention.

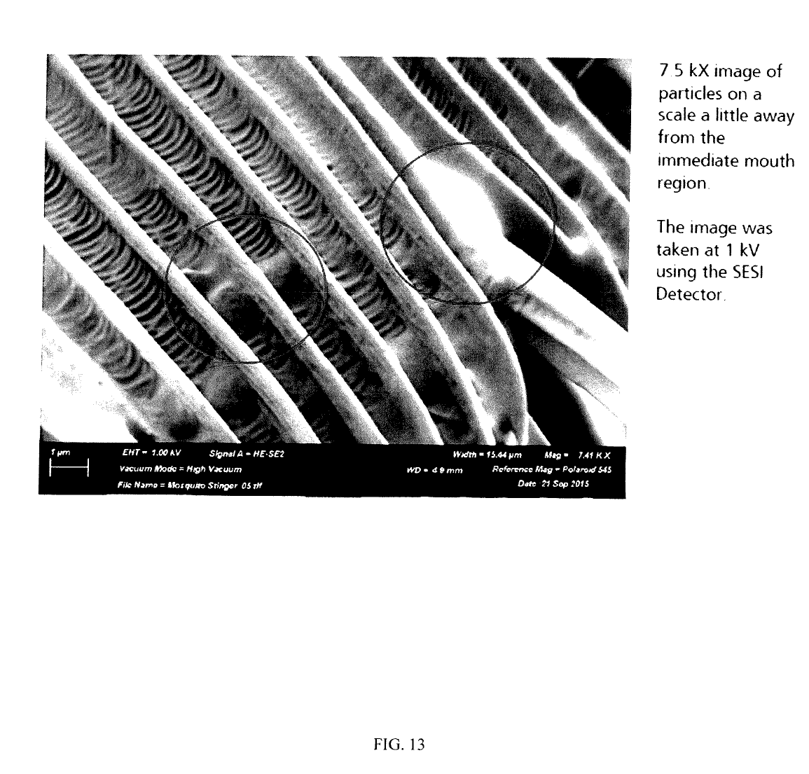

FIG. 14 shows a scanning electron microscopy image (9310×) of an area of mouth/proboscis of a mosquito exposed to titanium dioxide particles according to embodiments of the invention.

FIG. 15 shows a magnified image of FIG. 16 (26330×).

FIG. 16 shows mean feeding rates of the controls, pharmaceutically-acceptable carriers, compositions containing 10% titanium dioxide particles, and compositions containing 15% titanium dioxide particles presented in the studies listed in Example 1.

FIG. 17 shows mean decrease in feeding rate (i.e., percent change in mosquitos engorged compared to control) pharmaceutically-acceptable carriers, compositions containing 10% titanium dioxide particles, and compositions containing 15% titanium dioxide particles presented in the studies listed in Example 1.

FIG. 18 shows feeding rate of a control and a composition containing 10% rutile titanium dioxide particles coated with lecithin, 1% lemongrass, and a base cream as a pharmaceutically-acceptable carrier that underwent heating for four hours.

The patent or application file contains at least one drawing executed in color. Copies of this patent or patent application publication with color drawing(s) will be provided by the Office upon request and payment of the necessary fee.

### DETAILED DESCRIPTION

The present invention relates to a composition comprising particles, or the use thereof, for preventing mosquitoes from extracting blood from a host and/or from infecting a host with a mosquito-borne disease or infection, or for protecting a host from blood extraction and/or infection by a mosquito.

An average mosquito has a hollow proboscis which it employs to extract blood and inject saliva into its host. If a mosquito lands on an area of the dermis on which the composition of the invention has been applied, the mosquito and its proboscis will come into contact with the particles in the composition. Without being bound by theory, the composition may have desired effects which hinder the mosquito's efforts to feed. For instance, (i) the particles may present a physical barrier through which the proboscis must penetrate; (ii) the particles may be considerably smaller than the inside diameter of the proboscis but may cling together, resulting in an obstruction or irritant; (iii) the particles may cause irritation to the mosquito; or (iv) the composition may reduce the thermal signature of the host—on which mosquitos rely to search for capillaries—and thus assist in shielding capillaries and blinding the mosquito to its desired feeding target. Alternatively, in embodiments in which the composition comprises one or more organic components, the composition causes an airborne irritant/obfuscation effect where the organic components are irritating and or block sensor receptors that the mosquitoes employ for feeding.

### Composition

The composition of the invention comprises particles and a pharmaceutically acceptable carrier. The particles may comprise one or more metal oxides, such as titanium dioxide, zinc oxide, or a combination thereof.

In some embodiments, the particles are titanium dioxide, which is the naturally occurring oxide of titanium, having a chemical formula of TiO₂. It is a low cost, naturally occurring mineral. The two most common forms of titanium dioxide are rutile and anatase, and the particle in the composition of the invention may be of either form.

The particles may be micro-scale, nano-scale, or a combination of these sizes. In certain embodiments, the particles are between about 1 and about 100 nm.

The particles may be present in the composition in an amount of about 1 to about 25% by volume, or about 5 to about 15% by volume, in relation to the pharmaceutically acceptable carrier.

The particles may comprise an external coating. The external coating may comprise, for example, a hydrophilic polymer, propylene, propylene glycol phospholipid derivative such as lecithin, or a combination thereof. The ratio of the external coating to the particles may be about 0.1 to about 10% of the total weight of the particles, or about 0.5 to about 4% of the total weight of the particles.

In certain embodiments, the external coating is lecithin. Lecithin is a generic term to designate any group of yellow-brownish fatty substances occurring in animal and plant tissues composed of phosphoric acid, choline, fatty acids, glycerol, glycolipids, triglycerides, and phospholipids. Glycerophospholipids in lecithin include phosphatidylcholine, phosphatidylethanolamine, phosphatidylinositol, phosphatidylserine, and phosphatidic acid. Particles coated with lecithin may have hydrophilic properties, which may facilitate a uniform dispersal of the particles throughout the composition in which the particles are stacked at the nano-scale level. This stacking effect may present a layer of protection on the surface of the dermis.

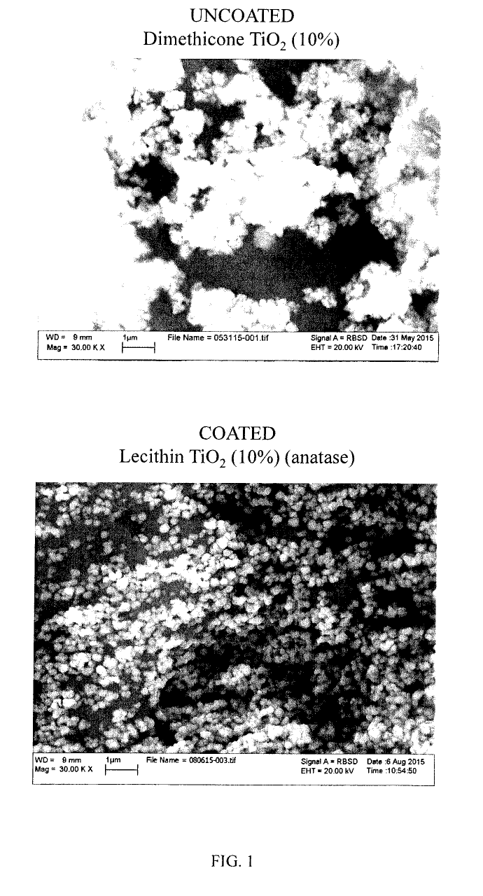

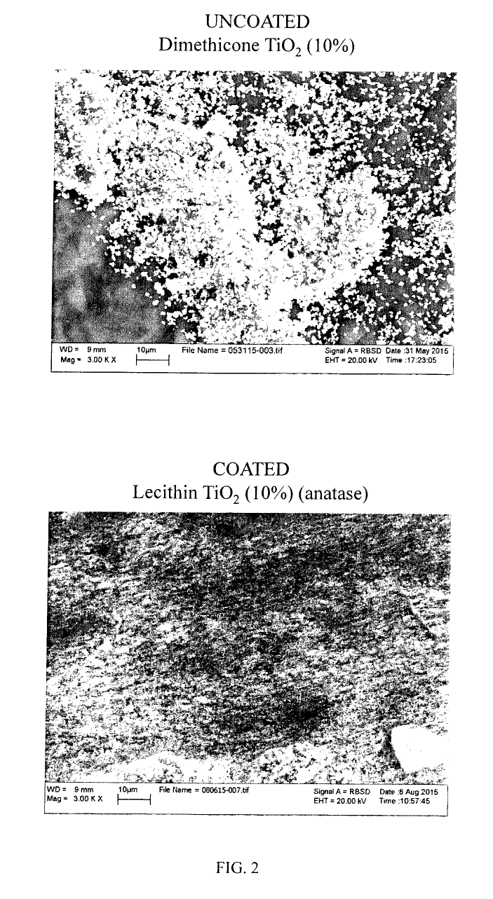

Without being bound by theory, the use of coated particles may present a uniform physical barrier to prevent or inhibit mosquitos from drawing blood from the host. This is illustrated in FIGS. 1 and 2, which are scanning electron microscopy images of a test membrane containing uncoated dimethicone titanium dioxide particles and titanium dioxide particles coated with lecithin, respectively. These images show that the coated particles may present a uniform barrier.

The composition may comprise one or more organic components. Examples of an organic component include, but are not limited to, pure forms or derivatives of lemongrass, citronella, picaridin (ir3535), chrysanthemum, cedar, and soybean. The organic components may be present in an amount of about 0.1 to about 5%, or about 1%, by volume of the composition.

The one or more organic components may be bound to the particles. In certain embodiments, the organic components may be infused into an external coating on the particles. The ratio of the organic components to the external coating may vary from about 1 to about 99%, depending on the absorbency of the particle and the level of effect of the organic component desired.

The one or more organic components may also be unbound to the particles. In other words, the organic components may be in the pharmaceutically acceptable carrier of the composition along with the particles.

The composition may be in the form of a cream, gel, lotion, suspension, spray or ointment. The composition may be suitable for topical administration to the dermis, and may form a substance that remains adherent to the surface of the dermis.

The pharmaceutically acceptable carrier may comprise one or more excipients known in the art for preparation of a cream, gel, lotion, suspension, spray, or ointment, including but not limited to emollients or softening agents, emulsifying or thickening agents, humectants and/or moisturizers, gelling agents, preservatives, oils, waxes, solvents, fragrances, dyes, antioxidants, antifoaming agents, stabilizing agents, pH adjusters, and the like.

Examples of suitable oily phases include, but are not limited to, hydrocarbons such as soft white paraffin, liquid paraffin, mineral oils, and the like. In some embodiments, an oily phase may be present in the composition in an amount of about 0.5 to about 20% by weight of the composition, or about 1 to about 15% by weight.

Examples of emulsifiers and thickeners include, but are not limited to, ethers of polyethylene glycol and fatty alcohols, cetyl alcohol, stearyl alcohol, sorbitol and other non-ionic emulsifying waxes, polyoxyethylene stearyl or cetyl alcohol ethers, glyceryl monostearate, polyoxyethylene sorbitan palmitate, Tween 20, 21, 40, 60, 65, 80, 81 or 85, polyoxyethylene glycol ethers of fatty alcohols such as cetearyl alcohol (Ceteareth-20), monoglycerides and fatty alcohols, fatty acid esters of alcohols having 3-21 carbon atoms, such as glyceryl monostearate and glyceryl monopalmitate. In certain embodiments, emulsifier-thickeners are present in an amount of about 2 to about 15%, or about 2 to about 12%, by weight of the composition.

Examples of emollients or softening agents include, but are not limited to, cetyl esters, wax and natural spermaceti wax, petrolatum, glyceryl monooleate, myristyl alcohol, and isopropyl palmitate. In some embodiments, emollients are present in an amount of up to about 10% by weight of the composition.

Examples of a humectant or moisturizer include, but are not limited to, glycerin, which may also be considered an emollient. In certain embodiments, glycerin is present in the formulation up to about 20% by weight, such as about 2 to about 12% by weight.

Examples of preservatives include, but are not limited to, methyl paraben, propyl paraben, quaternium-15, and chlorocresol. In some embodiments, preservatives are present in an amount of up to about 0.5% by weight of the composition.

Examples of suitable solvents include, but are not limited to, water and ethanol.

Examples of gelling agents include, but are not limited to, polysaccharides and gums, such as carboxymethylcellulose, alginic acid, agar, xanthan gum, gum arabic and the like.

Examples of antioxidants include, but are not limited to, vitamin E (tocopherol). In some embodiments, tocopherol salts such as tocopherol acetate are included in the composition.

In certain embodiments, the composition of the invention comprises the formulation shown in Table 1 below:

TABLE 1
Composition according to embodiments of the invention.

| Ingredient | Percentage by weight |
|---|---|
| Water | 65.30% |
| Hydroxyethylcellulose | 1.80% |
| Zemea Select Propanediol | 2.00% |
| SD alcohol 40-B (200 proof) | 10.00% |
| Syntran PC776 | 10.00% |
| Phenoxetol | 0.40% |
| Treated Titanium Dioxide | 10.00% |
| Lemongrass | 0.25% |
| KF-6011 | 0.25% |
| | 100.00% |

One of ordinary skill in the art would understand how to adjust the percentages by weight of the exemplified composition in order to accommodate different amounts of titanium dioxide and lemongrass, and to accommodate different organic components other than lemongrass.

The composition of the invention may be for use in a method of preventing mosquitoes from extracting blood from a host and/or from infecting a host with a mosquito-borne disease or infection, or a method of protecting a host from blood extraction and/or infection by a mosquito. This method is further described below.

Method of Prevention and/or Protection

The invention also relates to a method of preventing mosquitoes from extracting blood from a host and/or from infecting a host with a mosquito-borne disease or infection, or a method of protecting a host from blood extraction and/or infection by a mosquito. The method may comprise applying a composition of the invention to the dermis.

The composition may be applied onto the dermis through various means including, but not limited to, by hand, using a dispenser or applicator (such as a wipe into which the composition is infused), spraying the composition onto the dermis, etc.

The host may be a mammal, including humans, primates, livestock animals (such as sheep, pigs, cattle, horses, donkeys), laboratory test animals (such as mice, rabbits, rats, guinea pigs), and companion animals (such as dogs, cats).

The impact of applying the composition of the invention to the dermis may also include (i) reducing the available source of blood with which the female mosquito utilizes in the reproductive process and thus reducing the mosquito population near host-populated areas; and (ii) facilitating the death of the mosquito as a result of its interaction with the composition of the invention.

In some embodiments, the composition may prevent mosquitoes from extracting blood from a host and/or from infecting a host with a mosquito-borne disease or infection, or may protect a host from blood extraction and/or infection by a mosquito by forming a physical barrier.

The method of the invention prevent mosquitoes from infecting a host with a mosquito-borne disease or infection. Examples of mosquitoes include, but are not limited to, Ades egypti, Anopheles, Aedes albopictus, asian tiger, and the like. Examples of mosquito-borne diseases or infections may include, but are not limited to, malaria, yellow fever, Chikungunya, West Nile virus, dengue fever, filariasis, and Zika virus.

### Method of Preparation

The invention relates to a method of preparing a composition of the invention. The method may comprise admixing the particles and the pharmaceutically acceptable carrier. In certain embodiments, the method may also comprise admixing the particles with one or more organic components, either separately or together with the pharmaceutically-acceptable carrier.

In some embodiments, the particles may be homogenized within the pharmaceutically acceptable carrier. In certain embodiments, the particles may be spun in a centrifuge.

The particles may be coated with an external coating using techniques known in the art. In certain embodiments, the external coating may be combined with one or more organic components before the external coating is coated onto the particles. Alternatively, one or more organic components may be admixed with the particles after the particles are coated with the external coating.

The invention also relates to the use of the composition of the invention in the preparation of a medicament for preventing mosquitoes from extracting blood from a host and/or from infecting a host with a mosquito-borne disease or infection, or a for protecting a host from blood extraction and/or infection by a mosquito. This protection and/or prevention may be achieved by applying the medicament to the dermis of the host.

### EXAMPLES

### Example 1

Studies were performed to evaluate the efficacy of compositions according to embodiments of the invention.

Petri dishes (35 mm) were covered with stretched lamb skin, and bovine blood with anti-coagulant (0.3% sodium citrate) was injected into each Petri dish. The lamb skin on each Petri dish was (i) covered with a composition according to embodiments of the invention, (ii) covered with a pharmaceutically-acceptable carrier (e.g., a base cream) containing no particles, or (iii) absent any pharmaceutically-acceptable carrier or particles to serve as a control. Each Petri dish was heated and the temperature of the blood was maintained at 35-37 degrees Celsius using an infrared thermometer to monitor the temperature.

The Petri dishes were then exposed to approximately 450-650 female mosquitoes. The mosquitoes were allowed to feed for about one hour, and were then harvested and visually examined with an optical microscope to find evidence of blood ingestion (e.g., engorgement of blood). The mosquitos were scored as either no blood ingestion or engorged based on the microscopic examination.

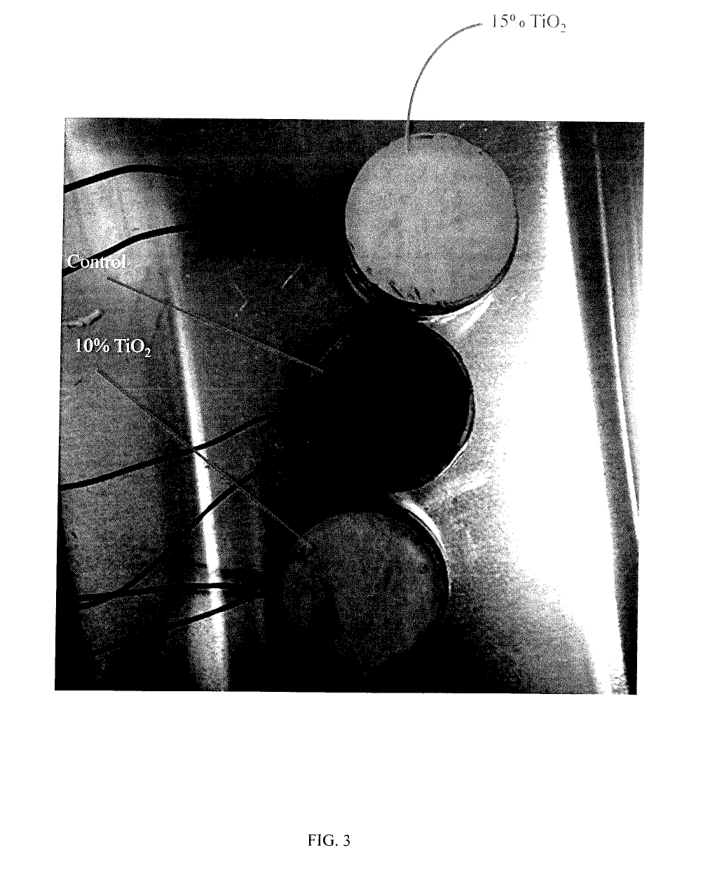

FIG. 3 provides an example of how Petri dishes were assembled for a study. In this case, the study involved a composition comprising 10% titanium dioxide coated with lecithin, a composition comprising 15% titanium dioxide coated with lecithin, and a control.

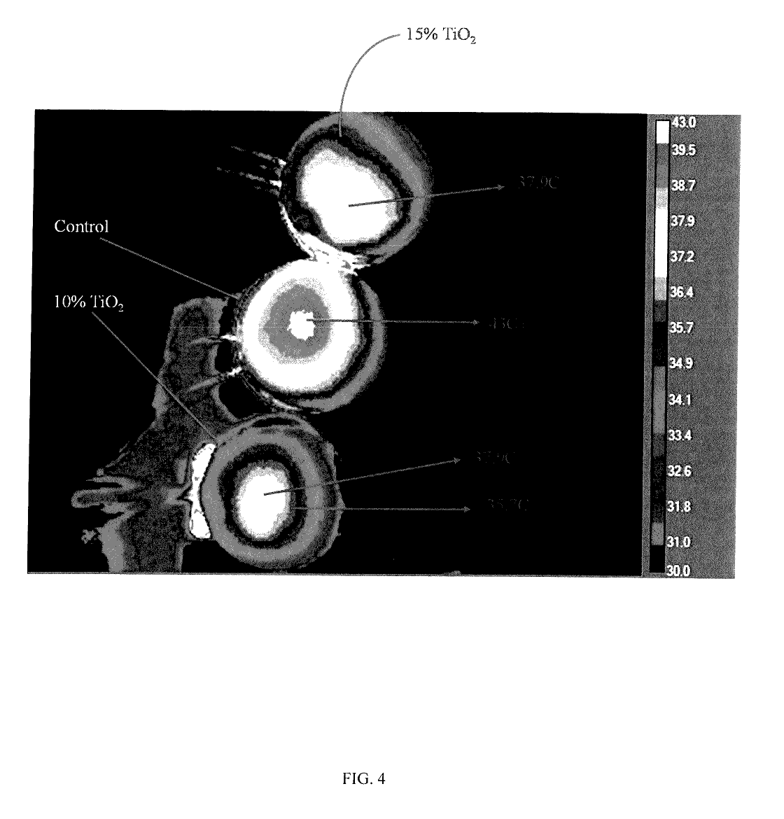

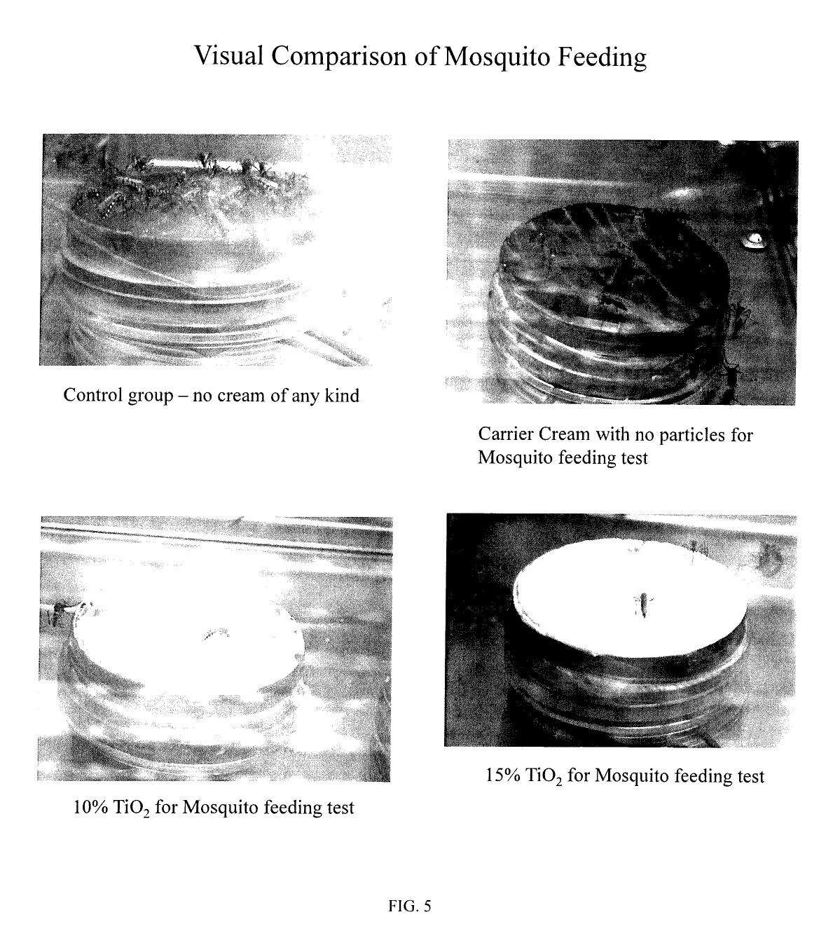

FIG. 4 shows how the temperature of the blood in the Petri dishes were monitored and maintained. Notably, the Petri dishes covered with either the composition containing 10% titanium dioxide coated with lecithin or the composition containing 15% titanium dioxide coated with lecithin exhibited a substantial decrease in the thermal signature. FIG. 5 demonstrates the behavior of the mosquitos during a study. Here, fewer mosquitos were on the Petri dishes covered with either the composition containing 10% titanium dioxide coated with lecithin or the composition containing 15% titanium dioxide coated with lecithin, as compared to Petri dishes covered with the pharmaceutically-acceptable carrier (base cream) or serving as the control

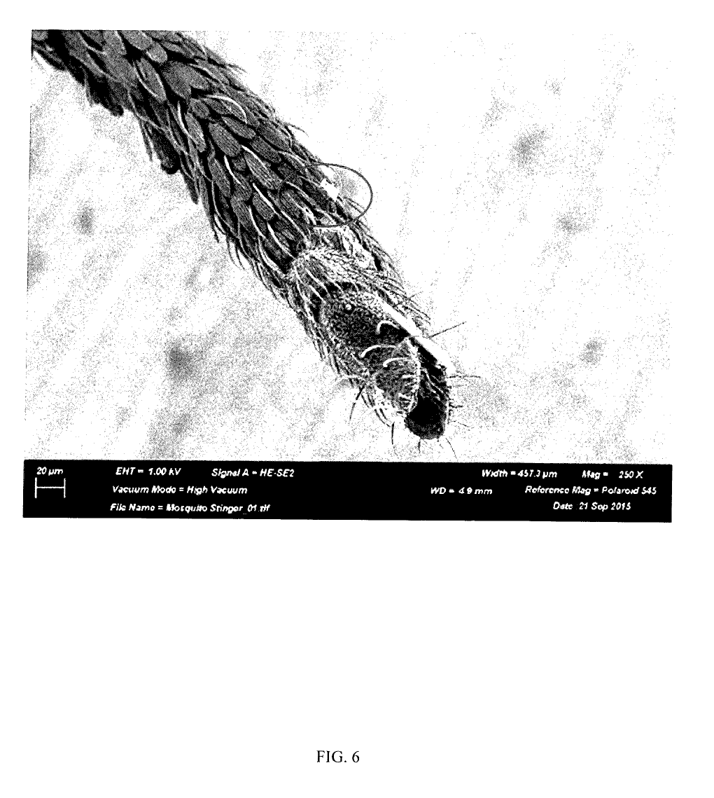

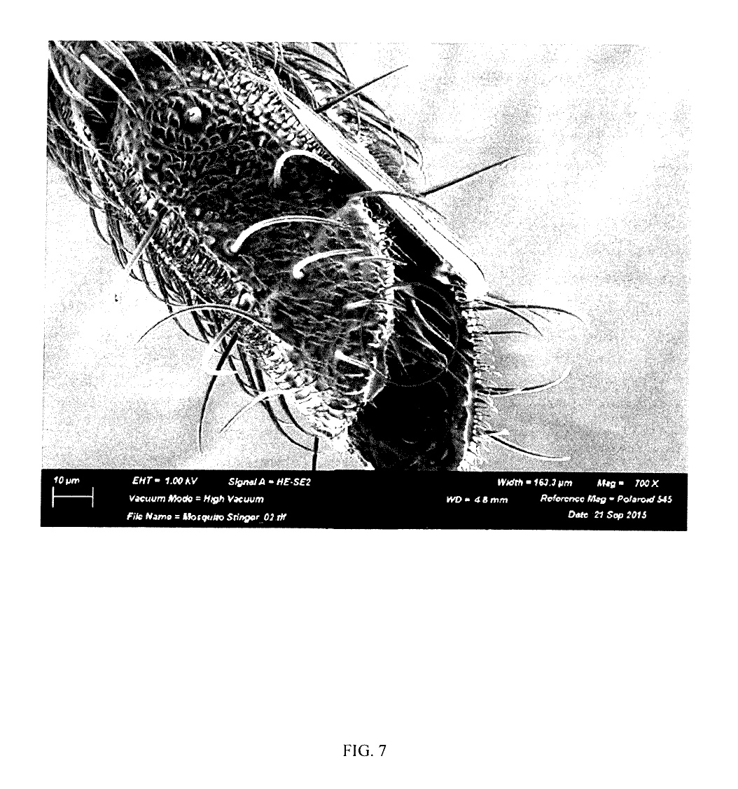

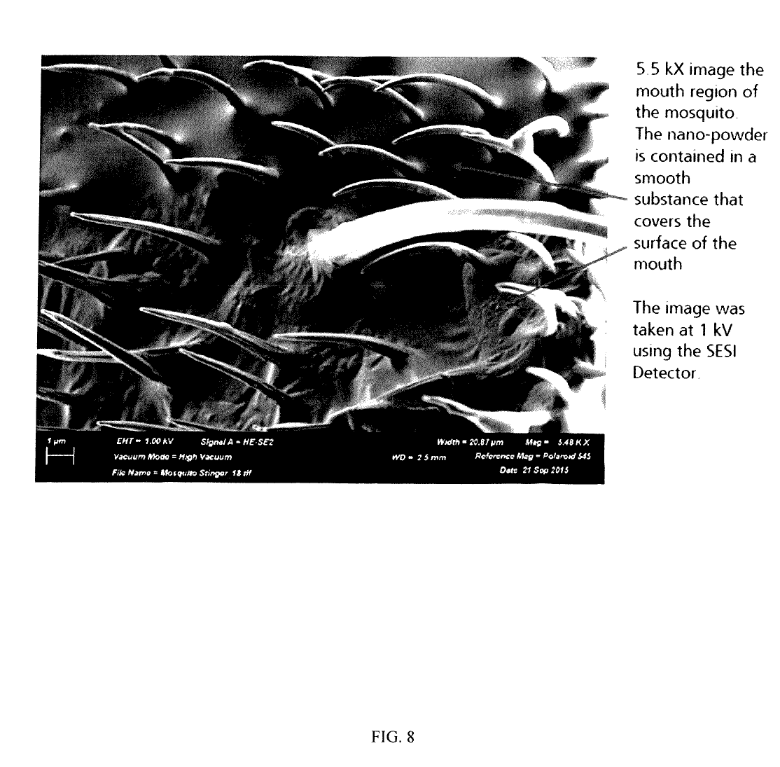

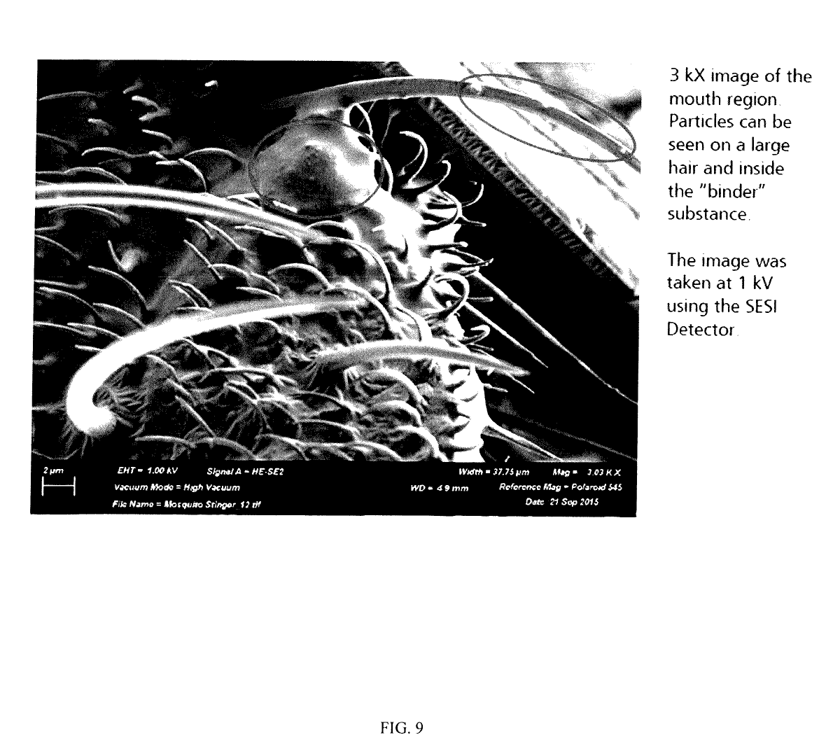

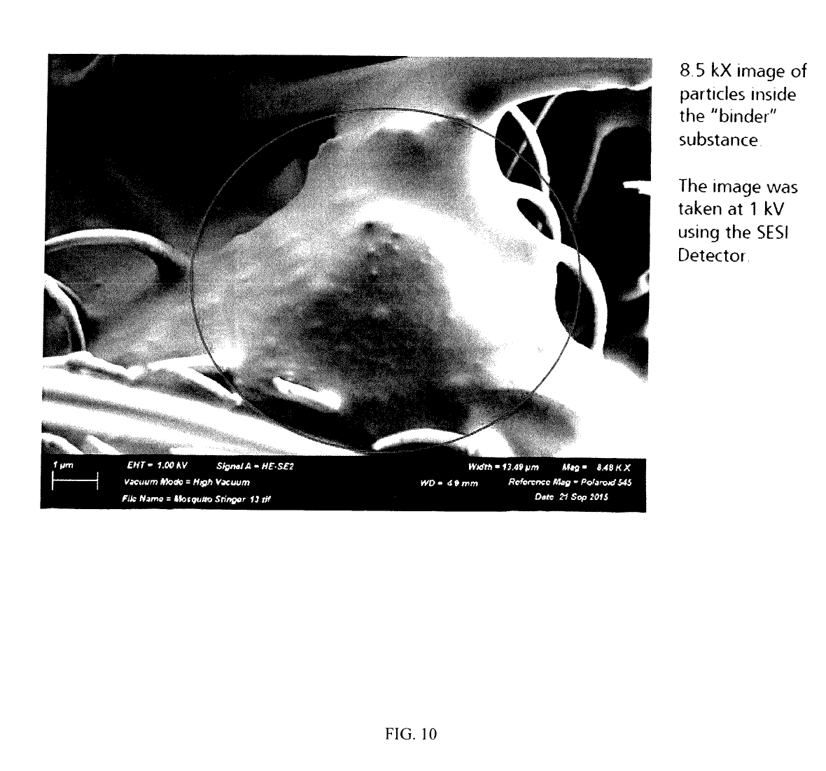

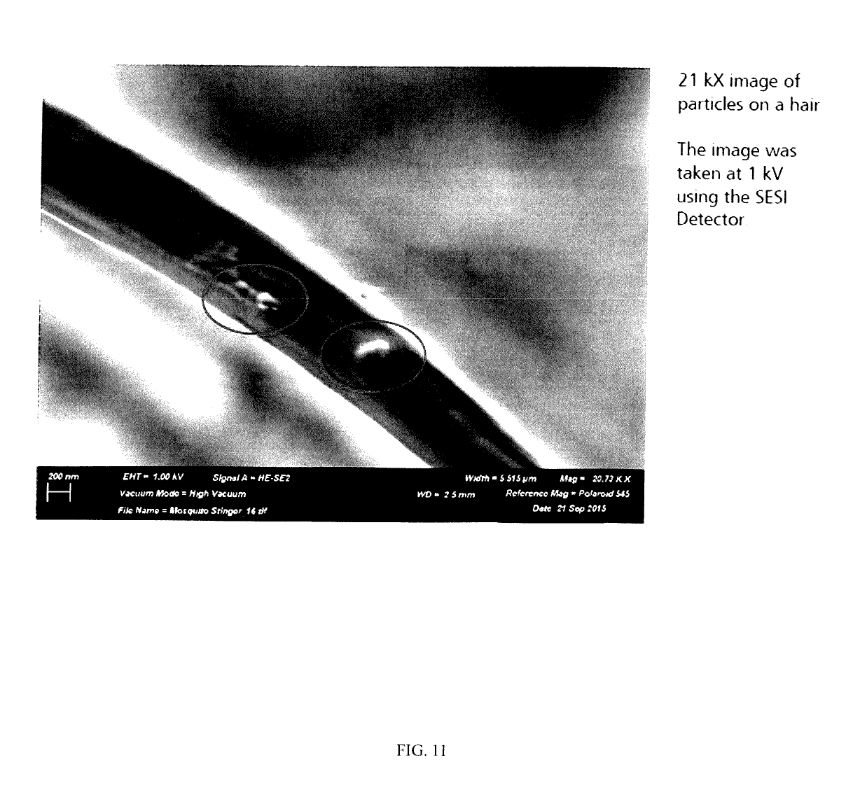

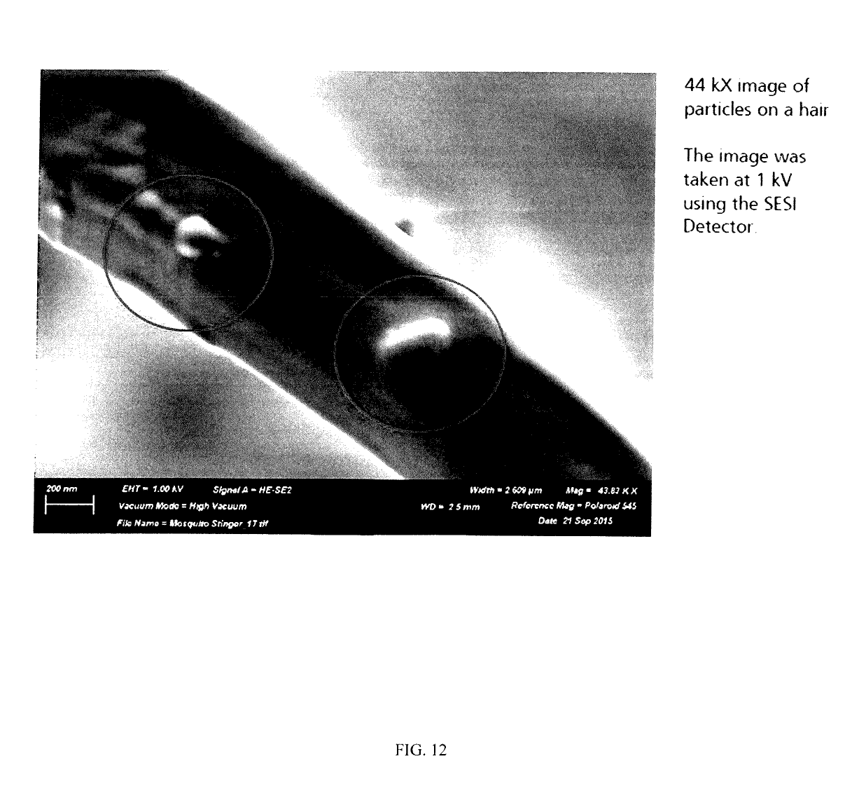

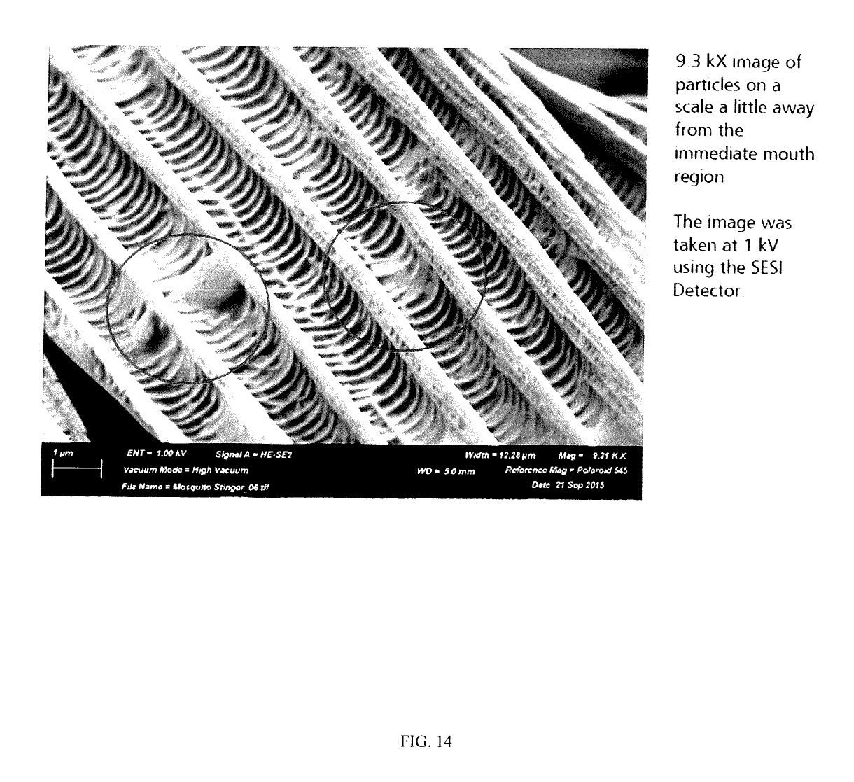

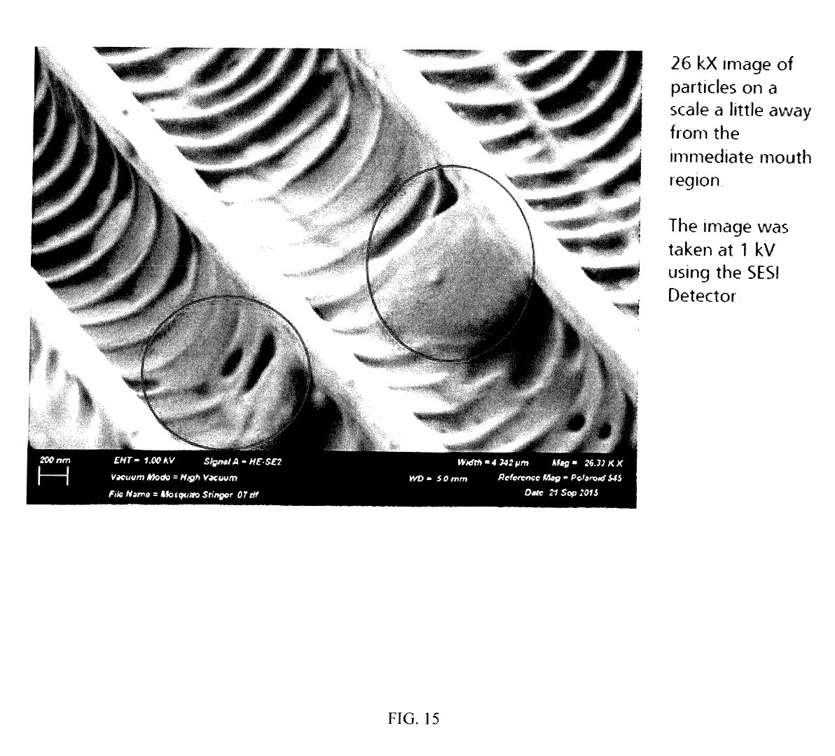

The impact on the mosquitos of titanium dioxide particles according to embodiments of the invention was further shown using scanning electron microscopy. FIGS. 6 and 7 are images of the proboscis of a mosquito and shows particles of titanium dioxide particles coated with lecithin embedded in the surface of the proboscis. FIG. 7 also shows the pharmaceutically-acceptable carrier fouling the hair structures on the perimeter of the mouth. FIGS. 8-10 are images of an area of the mouth/proboscis of a mosquito and shows particles of titanium dioxide particles coated with lecithin embedded in the surface of the proboscis as well as the pharmaceutically-acceptable carrier fouling the hair structures. FIGS. 11 and 12 are images of an area of the mouth/proboscis of a mosquito and shows particles of titanium dioxide particles coated with lecithin attached to a hair structure on the mosquito. Figure is an image of an area of the mouth/proboscis of a mosquito and shows particles of titanium dioxide particles coated with lecithin (bright area) inside the pharmaceutically-acceptable carrier cream fouling a scale-like feature on the surface of the proboscis. FIGS. 14 and 15 are images of an area of the mouth/proboscis of a mosquito and shows particles of titanium dioxide particles coated with lecithin inside the carrier of the invention fouling a scale-like feature on the surface of the proboscis.

The following studies were performed:

### Mar. 17, 2015 Study

The Petri dish assembly and methodology described above was used in a study comparing (a) a composition containing 15% titanium dioxide particles and a water-based gel as a pharmaceutically-acceptable carrier, (b) the water-based gel (without particles), and (c) a control.

These results, shown in Table 2 below, indicate that the Petri dish covered by the composition exhibited a lower feeding rate of the mosquitos as compared to the control.

TABLE 2
Results of the Mar. 17, 2015 Study

| | # of | | |
|---|---|---|---|
| | Mosquitos | # of Mosquitos | % of Mosquitos |
| | Tested | Engorged | Engorged |
| 15% titanium dioxide | 299 | 16 | 5.4% |
| particles and a water- | | | |
| based gel | | | |
| Water-based gel | 350 | 72 | 20.6% |
| Control | 327 | 126 | 38.5% |

These results indicate that the presence of the 15% titanium dioxide particles reduced the feeding rate of the mosquitos.

### Mar. 31, 2015 Study

The Petri dish assembly and methodology described above was used in another study comparing (a) a composition containing 15% titanium dioxide particles and a water-based gel as a pharmaceutically-acceptable carrier, (b) the water-based gel (without particles), and (c) a control.

The results, shown in Table 3 below, indicate that the Petri dish covered by the composition exhibited a lower feeding rate of the mosquitos as compared to the control.

TABLE 3
Results of the Mar. 31, 2015 Study

| | # of | # of | % of |
|---|---|---|---|
| | Mosquitos | Mosquitos | Mosquitos |
| | Tested | Engorged | Engorged |
| 15% titanium dioxide particles | 280 | 6 | 2.1% |
| and a water-based gel | | | |
| Water-based gel | 292 | 34 | 11.6% |
| Control | 301 | 55 | 18.3% |

These results further indicate that the presence of the 15% titanium dioxide particles reduced the feeding rate of the mosquitos.

### Apr. 3, 2015 Study

The Petri dish assembly and methodology described above was used in another study comparing (a) a composition containing 15% titanium dioxide particles and a water-based gel as a pharmaceutically-acceptable carrier, (b) a composition containing 25% titanium dioxide particles and a water-based gel as a pharmaceutically-acceptable carrier, (c) the water-based gel (without particles), and (d) a control.

The results, shown in Table 4 below, indicate that the Petri dishes covered by compositions containing the titanium dioxide particles exhibited a lower feeding rate of the mosquitos as compared to the control.

TABLE 4
Results of the Apr. 3, 2015 Study

| | # of | # of | % of |
|---|---|---|---|
| | Mosquitos | Mosquitos | Mosquitos |
| | Tested | Engorged | Engorged |
| 15% titanium dioxide particles | 318 | 8 | 2.5% |
| and a water-based gel | | | |
| 25% titanium dioxide particles | 265 | 7 | 2.7% |
| and a water-based gel | | | |
| Water-based gel | 270 | 8 | 3.0% |
| Control | 262 | 12 | 4.5% |

These results indicate that the presence of the titanium dioxide particles reduced the feeding rate of the mosquitos.

### May 1, 2015 Study

The Petri dish assembly and methodology described above was used in another study comparing (a) a composition containing 10% titanium dioxide particles and a water-based gel as a pharmaceutically-acceptable carrier, (b) a composition containing 15% titanium dioxide particles and a water-based gel as a pharmaceutically-acceptable carrier, (c) a control.

The results, shown in Table 5 below, indicate that the Petri dishes covered by compositions containing the titanium dioxide particles exhibited a lower feeding rate of the mosquitos as compared to the control.

TABLE 5
Results of the May 1, 2015 Study

| | % of | % Change in |
|---|---|---|
| | Mosquitos | Mosquitos Engorged |
| | Engorged | Compared to Control |
| 10% titanium dioxide particles | 13.53% | −64.06% |
| and a water-based gel | | |
| 15% titanium dioxide particles | 5.45% | −85.52% |
| and a water-based gel | | |
| Control | 37.64% | N/A |

These results indicate that the presence of the titanium dioxide particles reduced the feeding rate of the mosquitos.

### May 8, 2015 Study

The Petri dish assembly and methodology described above was used in another study comparing (a) a composition containing 5% titanium dioxide particles and a water-based gel as a pharmaceutically-acceptable carrier, (b) a composition containing 15% titanium dioxide particles and a water-based gel as a pharmaceutically-acceptable carrier, and (c) a control.

The results, shown in Table 6 below, indicate that the Petri dishes covered by compositions containing the titanium dioxide particles exhibited a lower feeding rate of the mosquitos as compared to the control.

TABLE 6
Results of the May 8, 2015 Study

| | # of | # of | % of |
|---|---|---|---|
| | Mosquitos | Mosquitos | Mosquitos |
| | Tested | Engorged | Engorged |
| 5% titanium dioxide particles | 377 | 48 | 12.73% |
| and a water-based gel | | | |
| 15% titanium dioxide particles | 466 | 39 | 8.37% |
| and a water-based gel | | | |
| Control | 342 | 117 | 34.21% |

These results indicate that the presence of the titanium dioxide particles reduced the feeding rate of the mosquitos.

### Jun. 19, 2015 Study

The Petri dish assembly and methodology described above was used in another study comparing (a) a composition containing 15% anatase titanium dioxide particles and a base cream as a pharmaceutically-acceptable carrier, (b) a composition containing 15% rutile titanium dioxide particles and a base cream as a pharmaceutically-acceptable carrier, and (c) a control.

The results, shown in Table 7 below, indicate that the Petri dishes covered by compositions containing the titanium dioxide particles exhibited a lower feeding rate of the mosquitos as compared to the control. Further, the Petri dish covered by the composition containing the rutile titanium dioxide particles exhibited a lower feeding rate of the mosquitos as compared to the Petri dish covered by the composition containing the anatase titanium dioxide particles.

TABLE 7
Results of the Jun. 19, 2015 Study

| | # of | # of | % of |
|---|---|---|---|
| | Mosquitos | Mosquitos | Mosquitos |
| | Tested | Engorged | Engorged |
| 15% anatase titanium dioxide | 274 | 34 | 12.4% |
| particles and a base cream | | | |
| 15% rutile titanium dioxide | 300 | 21 | 7.0% |
| particles and a base cream | | | |
| Control | 363 | 101 | 27.8% |

These results indicate that the presence of the titanium dioxide particles reduced the feeding rate of the mosquitos, and that rutile titanium dioxide particles may be more effective in reducing the feeding rate of mosquitos.

### Jun. 26, 2015 Study

The Petri dish assembly and methodology described above was used in another study comparing (a) a composition containing 15% anatase titanium dioxide particles and a base cream as a pharmaceutically-acceptable carrier, (b) a composition containing 15% rutile titanium dioxide particles and a base cream as a pharmaceutically-acceptable carrier, and (c) a control.

The results, shown in Table 8 below, indicate that the Petri dishes covered by compositions containing the titanium dioxide particles exhibited a lower feeding rate of the mosquitos as compared to the control. Further, the Petri dish covered by the composition containing the antase titanium dioxide particles and the Petri dish covered by the composition containing the rutile titanium dioxide particles exhibited nearly the same feeding rate of the mosquitos.

TABLE 8
Results of the Jun. 26, 2015 Study

| | # of | # of | % of |
|---|---|---|---|
| | Mosquitos | Mosquitos | Mosquitos |
| | Tested | Engorged | Engorged |
| 15% anatase titanium dioxide | 289 | 27 | 9.3% |
| particles and a base cream | | | |
| 15% rutile titanium dioxide | 350 | 34 | 9.7% |
| particles and a base cream | | | |
| Control | 393 | 121 | 30.8% |

These results indicate that the presence of the titanium dioxide particles reduced the feeding rate of the mosquitos, and that anatase titanium dioxide particles and rutile titanium dioxide particles may have the same efficacy in reducing the feeding rate of mosquitos.

### Jul. 17, 2015 Study

The Petri dish assembly and methodology described above was used in another study comparing (a) a composition containing 10% anatase titanium dioxide particles coated with lecithin and a base cream as a pharmaceutically-acceptable carrier, (b) a composition containing 15% anatase titanium dioxide particles coated with lecithin and a base cream as a pharmaceutically-acceptable carrier, and (c) a control.

The results, shown in Table 9 below, indicate that the Petri dishes covered by compositions containing the titanium dioxide particles exhibited a lower feeding rate of the mosquitos as compared to the control. Further, the Petri dish covered by the composition containing the 10% antase titanium dioxide particles and the Petri dish covered by the composition containing the 15% antase titanium dioxide particles exhibited nearly the same feeding rate of the mosquitos.

TABLE 9
Results of the Jul. 17, 2015 Study

| | # of | # of | % of |
|---|---|---|---|
| | Mosquitos | Mosquitos | Mosquitos |
| | Tested | Engorged | Engorged |
| 10% anatase titanium dioxide | 274 | 3 | 1.1% |
| particles coated with lecithin | | | |
| and a base cream | | | |
| 15% anatase titanium dioxide | 213 | 3 | 1.4% |
| particles coated with lecithin | | | |
| and a base cream | | | |
| Control | 310 | 45 | 14.5% |

These results indicate that the presence of the titanium dioxide particles coated with lecithin reduced the feeding rate of the mosquitos, and that 10% anatase titanium dioxide particles and 15% anatase titanium dioxide particles may have the same efficacy in reducing the feeding rate of mosquitos.

### Jul. 24, 2015 Study

The Petri dish assembly and methodology described above was used in another study comparing (a) a composition containing 10% rutile titanium dioxide particles coated with lecithin and a base cream as a pharmaceutically-acceptable carrier, (b) a composition containing 15% rutile titanium dioxide particles coated with lecithin and a base cream as a pharmaceutically-acceptable carrier, and (c) a control.

The results, shown in Table 10 below, indicate that the Petri dishes covered by compositions containing the titanium dioxide particles exhibited a lower feeding rate of the mosquitos as compared to the control. Further, the Petri dish covered by the composition containing the 10% rutile titanium dioxide particles and Petri dish covered by the composition containing the 15% ruffle titanium dioxide particles exhibited nearly the same feeding rate of the mosquitos.

TABLE 10
Results of the Jul. 24, 2015 Study

| | # of | # of | % of |
|---|---|---|---|
| | Mosquitos | Mosquitos | Mosquitos |
| | Tested | Engorged | Engorged |
| 10% rutile titanium dioxide | 240 | 263 | 239 |
| particles coated with lecithin | | | |
| and a base cream | | | |
| 15% rutile titanium dioxide | 38 | 12 | 9 |
| particles coated with lecithin | | | |
| and a base cream | | | |
| Control | 15.8% | 4.6% | 3.8% |

These results indicate that the presence of the titanium dioxide particles coated with lecithin reduced the feeding rate of the mosquitos, and that 10% rutile titanium dioxide particles and 15% rutile titanium dioxide particles may have the same efficacy in reducing the feeding rate of mosquitos.

### Jul. 31, 2015 Study

The Petri dish assembly and methodology described above was used in another study comparing (a) a composition containing 10% rutile titanium dioxide particles coated with lecithin, a pigment, and a base cream as a pharmaceutically-acceptable carrier, (b) a composition containing 15% rutile titanium dioxide particles coated with lecithin, a pigment, and a base cream as a pharmaceutically-acceptable carrier, and (c) a control.

The results, shown in Table 11 below, indicate that the Petri dishes covered by compositions containing the titanium dioxide particles exhibited a lower feeding rate of the mosquitos as compared to the control. Further, the Petri dish covered by the composition containing the 15% rutile titanium dioxide particles with pigment exhibited a lower feeding rate of the mosquitos as compared to the Petri dish covered by the composition containing the 10% rutile titanium dioxide particles with pigment.

TABLE 11
Results of the Jul. 31, 2015 Study

| | % of | % Change in |
|---|---|---|
| | Mosquitos | Mosquitos Engorged |
| | Engorged | Compared to Control |
| 10% rutile titanium dioxide | 31.6% | −32.0% |
| particles coated with lecithin, a | | |
| pigment, and a base cream | | |
| 15% rutile titanium dioxide | 25.7% | −44.7% |
| particles coated with lecithin, a | | |
| pigment, and a base cream | | |
| Control | 46.5% | N/A |

These results indicate that the presence of the titanium dioxide particles coated with lecithin reduced the feeding rate of the mosquitos, and that 15% rutile titanium dioxide particles with a pigment may be more effective in reducing the feeding rate of mosquitos than 10% rutile titanium dioxide particles with a pigment.

### Aug. 7, 2015 Study

The Petri dish assembly and methodology described above was used in another study comparing (a) a composition containing 10% anatase titanium dioxide particles coated with lecithin, a pigment, and a base cream as a pharmaceutically-acceptable carrier, (b) a composition containing 15% anatase titanium dioxide particles coated with lecithin, a pigment, and a base cream as a pharmaceutically-acceptable carrier, and (c) a control.

The results, shown in Table 12 below, indicate that the Petri dishes covered by compositions containing the titanium dioxide particles exhibited a lower feeding rate of the mosquitos as compared to the control. Further, the Petri dish covered by the composition containing the 10% anatase titanium dioxide particles with pigment and the Petri dish covered by the composition containing the 15% anatase titanium dioxide particles with pigment exhibited nearly the same feeding rate of the mosquitos.

TABLE 12
Results of the Aug. 7, 2015 Study

| | # of | # of | % of |
|---|---|---|---|
| | Mosquitos | Mosquitos | Mosquitos |
| | Tested | Engorged | Engorged |
| 10% anatase titanium dioxide | 311 | 20 | 6.4% |
| particles coated with lecithin, a | | | |
| pigment, and a base cream | | | |
| 15% anatase titanium dioxide | 269 | 16 | 6.0% |
| particles coated with lecithin, a | | | |
| pigment, and a base cream | | | |
| Control | 245 | 19 | 7.8% |

These results indicate that the presence of the titanium dioxide particles coated with lecithin reduced the feeding rate of the mosquitos, and that 10% anatase titanium dioxide particles with a pigment and 15% anatase titanium dioxide particles with a pigment may have the same efficacy in reducing the feeding rate of mosquitos.

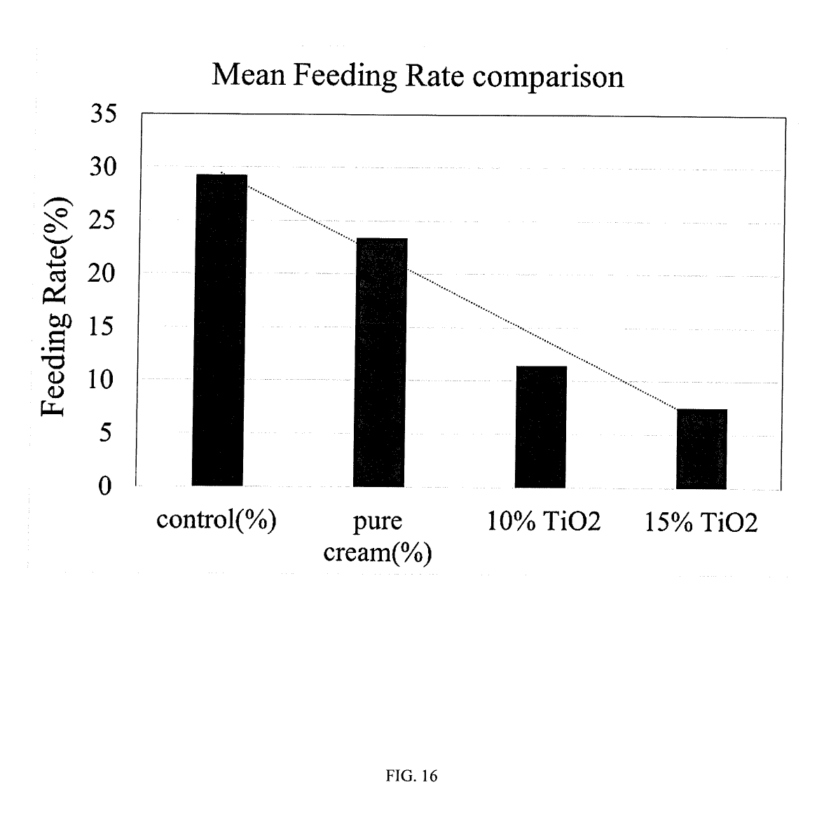

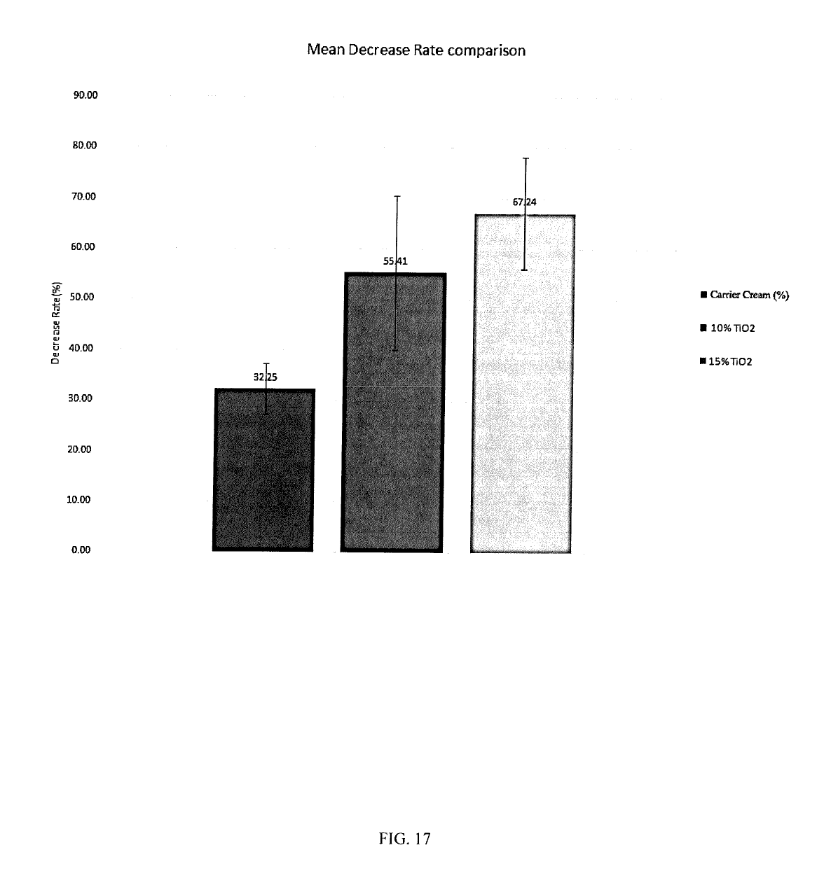

FIG. 16 shows the mean feeding rates (i.e., percent of mosquitoes engorged) of the controls, pharmaceutically-acceptable carriers, compositions containing 10% titanium dioxide particles, and compositions containing 15% titanium dioxide particles presented in the studies listed in Example 1. FIG. 17 shows the mean decrease in feeding rate (i.e., percent change in mosquitos engorged compared to control) pharmaceutically-acceptable carriers, compositions containing 10% titanium dioxide particles, and compositions containing 15% titanium dioxide particles presented in the studies listed in Example 1. Based on these data, the presence of the titanium dioxide particles reduced the feeding rate of the mosquitos, and 15% titanium dioxide particles may be more effective in reducing the feeding rate of mosquitos than 10% titanium dioxide particles.

### Example 2

Studies were performed to evaluate the efficacy of compositions according to embodiments of the invention.

Petri dishes (35 mm) were covered with stretched lamb skin, and bovine blood with anti-coagulant (0.3% sodium citrate) was injected into each Petri dish. The lamb skin on each Petri dish was (i) covered with a composition according to embodiments of the invention, (ii) covered with Off!, (iii) covered with a pharmaceutically-acceptable carrier and lemongrass, or (iv) absent any pharmaceutically-acceptable carrier or particles to serve as a control. Each Petri dish was heated and the temperature of the blood was maintained at 35-37 degrees Celsius using an infrared thermometer to monitor the temperature.

The Petri dishes were then exposed to approximately 450-650 female mosquitoes. The mosquitoes were allowed to feed for about one hour, and were then harvested and visually examined with an optical microscope to find evidence of blood ingestion (e.g., engorgement of blood). The mosquitos were scored as either no blood ingestion or engorged based on the microscopic examination.

The following studies were performed:

### Oct. 9, 2015 Study

The Petri dish assembly and methodology described above was used in a study comparing (a) a composition containing 10% titanium dioxide particles coated with lecithin, 1% lemongrass, and a base cream as a pharmaceutically-acceptable carrier, and (b) a control.

The results, shown in Table 13 below, indicate that the Petri dish covered by the compositions containing the titanium dioxide particles with lemongrass exhibited a lower feeding rate of the mosquitos as compared to the control.

TABLE 13
Results of the Oct. 9, 2015 Study

| | % of | % Change in |
|---|---|---|
| | Mosquitoes | Mosquitos Engorged |
| | Engorged | Compared to Control |
| 10% titanium dioxide particles | 0.34% | −99% |
| coated with lecithin, 1% | | |
| lemongrass, and a base cream | | |
| Control | 34.0% | N/A |

These results indicate that the presence of the titanium dioxide particles coated with lecithin and lemongrass reduced the feeding rate of the mosquitos.

### Oct. 23, 2015 Study

The Petri dish assembly and methodology described above was used in another study comparing (a) a composition containing 10% rutile titanium dioxide particles coated with lecithin, 1% lemongrass, and a base cream as a pharmaceutically-acceptable carrier, (b) Off!, and (c) a control.

The results, shown in Table 14 below, indicate that the Petri dish covered by the composition containing the titanium dioxide particles with lemongrass exhibited a lower feeding rate of the mosquitos as compared to the control. Further, the Petri dish covered by the composition containing the titanium dioxide particles with lemongrass and the Petri dish covered by Off! exhibited nearly the same feeding rate of the mosquitos.

TABLE 14
Results of the Oct. 23, 2015 Study

| | # of | # of | % of |
|---|---|---|---|
| | Mosquitos | Mosquitos | Mosquitos |
| | Tested | Engorged | Engorged |
| 10% titanium dioxide particles | 285 | 1 | 0.35% |
| coated with lecithin, 1% | | | |
| lemongrass, and a base cream | | | |
| Off! | 319 | 0 | 0% |
| Control | 367 | 132 | 36.0% |

These results indicate that the presence of the titanium dioxide particles coated with lecithin and lemongrass reduced the feeding rate of the mosquitos, and that 10% titanium dioxide particles with lemongrass and Off! may have the same efficacy in reducing the feeding rate of mosquitos.

### Nov. 13, 2015 Study

The Petri dish assembly and methodology described above was used in another study comparing (a) a composition containing 10% rutile titanium dioxide particles coated with lecithin and a base cream as a pharmaceutically-acceptable carrier, (b) a base cream as a pharmaceutically-acceptable carrier and 1% lemongrass, and (c) a control.

The results, shown in Table 15 below, indicate that the Petri dish covered by the composition containing the titanium dioxide particles exhibited a lower feeding rate of the mosquitos as compared to the control. Further, the Petri dish covered by the composition containing base cream with lemongrass exhibited a lower feeding rate of the mosquitos as compared to the Petri dish covered by the composition containing titanium dioxide particles.

TABLE 15
Results of the Nov. 13, 2015 Study

| | # of | # of | % of |
|---|---|---|---|
| | Mosquitos | Mosquitos | Mosquitos |
| | Tested | Engorged | Engorged |
| 10% rutile titanium dioxide | 348 | 17 | 4.9% |
| particles coated with lecithin, | | | |
| and a base cream | | | |
| base cream and 1% lemongrass | 402 | 2 | 0.5% |
| Control | 330 | 34 | 10.3% |

These results indicate that the presence of the titanium dioxide particles coated with lecithin reduced the feeding rate of the mosquitos, and that the presence of lemongrass is effective in reducing the feeding rate of mosquitos.

### Mar. 18, 2016 Study

The Petri dish assembly and methodology described above was used in another study comparing (a) a composition containing 10% rutile titanium dioxide particles coated with lecithin and a base cream as a pharmaceutically-acceptable carrier, (b) a composition containing 10% rutile titanium dioxide particles coated with lecithin and a base cream as a pharmaceutically-acceptable carrier that underwent heating for four hours, and (c) a control.

The results, shown in Table 16 below, indicate that the Petri dish covered by the composition containing the titanium dioxide particles exhibited a lower feeding rate of the mosquitos as compared to the control. Further, the Petri dish covered by the composition containing the titanium dioxide particles coated with lecithin and the Petri dish covered by the composition containing the titanium dioxide particles coated with lecithin and was heated for four hours exhibited nearly the same feeding rate of the mosquitos.

TABLE 16
Results of the Mar. 18, 2016 Study

| | # of | # of | % of |
|---|---|---|---|
| | Mosquitos | Mosquitos | Mosquitos |
| | Tested | Engorged | Engorged |
| 10% rutile titanium dioxide | 271 | 321 | 287 |
| particles coated with lecithin, | | | |
| and a base cream | | | |
| 10% rutile titanium dioxide | 113 | 20 | 17 |
| particles coated with lecithin, | | | |
| and a base cream and heated | | | |
| for four hours | | | |
| Control | 41.7% | 6.2% | 5.9% |

These results indicate that the presence of the titanium dioxide particles coated with lecithin reduced the feeding rate of the mosquitos, and that heating the composition did not impact the efficacy of the composition.

### Apr. 22, 2016 Study

The Petri dish assembly and methodology described above was used in another study comparing (a) a composition containing 10% rutile titanium dioxide particles coated with lecithin, 1% lemongrass, and a base cream as a pharmaceutically-acceptable carrier that underwent heating for four hours, and (b) a control.

The results, shown in Table 17 below, indicate that the Petri dish covered by the composition containing the titanium dioxide particles exhibited a lower feeding rate of the mosquitos as compared to the control.

TABLE 17
Results of the Apr. 22, 2016 Study

| | # of | # of | % of |
|---|---|---|---|
| | Mosquitos | Mosquitos | Mosquitos |
| | Tested | Engorged | Engorged |
| 10% rutile titanium dioxide | 272 | 10 | 3.7% |
| particles coated with lecithin, | | | |
| 1% lemongrass, and a base | | | |
| cream and heated for four | | | |
| hours | | | |
| Control | 347 | 112 | 32.3% |

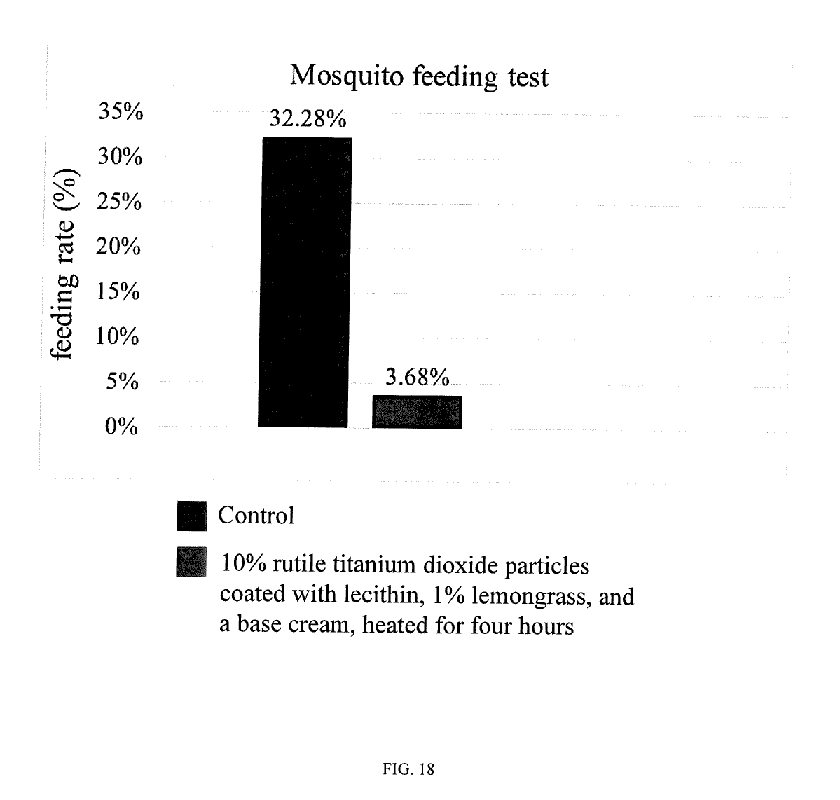

These results indicate that the presence of the titanium dioxide particles coated with lecithin reduced the feeding rate of the mosquitos. These results are further illustrated in FIG. 18.

Those of ordinary skill in the art will recognize that many modifications and variations of the present invention may be implemented without departing from the spirit or scope of the invention. Thus, it is intended that the present invention cover the modification and variations of this invention provided they come within the scope of the appended claims and their equivalents.

What is claimed is:

1. A composition for topical administration comprising particles and a pharmaceutically acceptable carrier, wherein the particles comprise a metal oxide.

2. The composition of claim 1, wherein the metal oxide is selected from the group consisting of titanium oxide, zinc oxide, and a combination thereof.

3. The composition of claim 2, wherein the metal oxide is titanium oxide.

4. The composition of claim 1, wherein the particles are present in an amount of about 1 to about 25% by volume of the composition.

5. The composition of claim 1, wherein the particle is coated with an external coating.

6. The composition of claim 5, wherein the external coating comprises a hydrophilic polymer, propylene, propylene glycol phospholipid derivative, or a combination thereof.

7. The composition of claim 6, wherein the external coating comprises lecithin.

8. The composition of claim 5, wherein the external coating is present in an amount of about 0.1 to about 10% of the total weight of the particles.

9. The composition of claim 1, further comprising one or more organic components.

10. The composition of claim 9, wherein the organic components are selected from the group consisting of lemongrass, citronella, picaridin (ir3535), chrysanthemum, cedar, soybean, and a combination thereof.

11. The composition of claim 9, wherein the organic components are not bound to the particles.

12. The composition of claim 9, wherein the organic components are bound to the particles.

13. The composition of claim 10, wherein the organic components are infused an external coating on the particles.

14. The composition of claim 10, wherein the organic components are present in an amount of about 0.1 to about 5% by volume of the composition.

15. The composition of claim 1, wherein the composition is in a form of a cream, gel, lotion, suspension, spray, or ointment.

16. The composition of claim 1, wherein the composition is for use in a method of preventing mosquitoes from extracting blood from a host or from infecting a host with a mosquito-borne disease or infection, or a method of protecting a host from blood extraction or infection by a mosquito.

17. A method of preventing mosquitoes from extracting blood from a host or from infecting a host with a mosquito-borne disease or infection, said method comprising applying to the dermis of the host a composition comprising particles and a pharmaceutically acceptable carrier, wherein the particles comprise a metal oxide.

18. The method of claim 17, wherein the composition is applied to the dermis by hand, using a dispenser or applicator, or spraying the composition onto the dermis.

19. A method of protecting a host from blood extraction and/or infection by a mosquito, said method comprising applying to the dermis of the host a composition comprising particles and a pharmaceutically acceptable carrier, wherein the particles comprise a metal oxide.

20. The method of claim 19, wherein the composition is applied to the dermis by hand, using a dispenser or applicator, or spraying the composition onto the dermis.
